(19) United States
(12) Patent Application Publication
(10) Pub. No.: US 2020/0150432 A1
(43) Pub. Date: May 14, 2020

(54) AUGMENTED REAL IMAGE DISPLAY DEVICE FOR VEHICLE

(71) Applicant: NIPPON SEIKI CO., LTD., Niigata (JP)

(72) Inventor: Tadashige MAKINO, Niigata (JP)

(73) Assignee: NIPPON SEIKI CO., LTD., Niigata (JP)

(21) Appl. No.: 16/631,055

(22) PCT Filed: Jul. 26, 2018
(86) PCT No.: PCT/JP2018/028042

§ 371 Date: Jan. 14, 2020

(30) Foreign Application Priority Data
Jul. 31, 2017 (JP) 2017-148670

(51) Int. Cl. G02B 27/01; G06T 11/00; B60K 35/00; B60R 11/02

(52) U.S. Cl. CPC G02B 27/0101; G06T 11/001; B60K 35/00; B60R 11/04; B60K 2370/1529; B60K 2370/177; B60K 2370/166; B60R 11/0229

(57) ABSTRACT

The present invention presents information while maintaining the visibility of a foreground. An object selection unit 21 selects a specific real object 300 from with a foreground 200, a display position adjustment unit 22 controls a position of an augmented real image V so that the augmented real image V adjoins or at least partly overlaps the real object 300 selected by the object selection unit 21, and an image processing unit 23 makes an adjustment so that a color of a portion of the augmented real image V visible to a user is the same as or similar to the color of the real object 300 as acquired by a color information acquisition unit 30.

### TECHNICAL FIELD

The present invention relates to an augmented real image display device for a vehicle that is used in the vehicle and allows for visual recognition of a virtual image superimposed on a foreground of the vehicle.

### BACKGROUND ART

Conventionally, there is a known augmented real image display device for a vehicle that allows for visual recognition of a virtual image superimposed on a landscape (see, for example, Patent Document 1). Such an augmented real image display device for a vehicle uses, as a display device, for example, a Head Mounted Display (HMD) device mounted on the head, and projects display light from the display unit toward a user through a projection optical system or a light guide so that the user visually recognizes a virtual image of a display image indicated by the display light. The user can visually recognize the virtual image generated by the HMD device with the virtual image being superimposed on the front real landscape. Further, a technique called Augmented Reality (AR) can be applied to the HMD device. That is, by displaying an augmented real image (virtual image) associated with the position of a real object existing in the real landscape, it is possible to give the user a feeling as if the augmented real image exists in the real landscape.

Further, as an HMD device, Patent Document 2 discloses a technique for changing a color of an augmented real image in accordance with the color of a real object existing in a real landscape. The technique disclosed in Patent Document 2 detects the color of a real object that exists in the real world detected by a color detection unit, and adjusts the color of the augmented real image in consideration of the color of the real object, even if the real object and the augmented real image are visually recognized as being superimposed on each other, so that the user can visually recognize the augmented real image with a desired design color.

### PRIOR ART DOCUMENT

### Patent Document

Patent Document 1: Japanese Unexamined Patent Application Publication No. 2014-119786

Patent Document 2: Japanese Unexamined Patent Application Publication No. 2016-81209

### SUMMARY OF THE INVENTION

### Problems to be Solved by the Invention

As described above, an augmented real image display device for a vehicle can provide information through a virtual image superimposed on a real landscape but the virtual image is always visible in the user's field of view. This causes a problem that it is troublesome for the user to recognize an increased amount of information to be displayed, resulting in a low recognizability of each piece of information with the user bothering with organizing the information.

The present invention has been made in view of the above problem, and an object thereof is to provide an augmented real image display device for a vehicle, capable of providing information while maintaining the foreground visibility.

### Solution to Problem

To solve the above-described problems, the present invention adopts the following means

The summary of the augmented real image display device for a vehicle according to the present invention is that a color of a real object existing in the foreground of the vehicle is detected, and an augmented real image having a color that is the same as or similar to the color of the real object is displayed so that the augmented real image adjoins or partly overlaps the real object, thus to make it hard to obstruct a field of view in the foreground direction visually recognized by the user and to make it hard to turn visual attention to the virtual image (the augmented real image).

An augmented real image display device for a vehicle according to a first aspect of the present invention is an augmented real image display device for a vehicle that displays an augmented real image (V) including presentation information so that the augmented real image (V) is superimposed on a foreground (200) of the vehicle. The augmented real image display device for a vehicle includes an image display unit (10) configured to allow a user to visually recognize the augmented real image (V); an object selection unit (21) configured to select a specific real object (300) from the foreground (200); a display position adjustment unit (22) configured to control a position of the augmented real image (V) so that the augmented real image (V) adjoins or at least partly overlaps the real object (300) selected by the object selection unit (21); a color information acquisition unit (30, 70) configured to acquire color information of the real object (300); and an image processing unit (23) configured to make an adjustment so that the color of a portion of the augmented real image (V) visible to the user is the same as or similar to the color of the real object (300). The augmented real image display device for a vehicle selects a specific real object from among real objects existing in a real landscape, and displays an augmented real image in the same color as that of the real object in a state where the augmented real image adjoins or partly overlaps the real object. Therefore, the augmented real image is displayed to be inconspicuous at a position adjacent to the real object that originally exists in the real landscape, and thus it is possible to harmonize the image with the real landscape with being less likely to be conspicuous, as compared to the case of displaying the image at a position away from the real object. Accordingly, this makes it possible for the user to concentrate on the driving operation with being less likely to turn visual attention to the image.

Further, in the augmented real image display device for a vehicle according to a second aspect dependent on the first aspect, the augmented real image (V) may include an information image (VA) indicating the presentation information, and a background image (VB) surrounding at least a portion of a periphery of the information image (VA), and the image processing unit (23) may be configured to make an adjustment so that the color of the background image (VB) visually recognized by the user is the same as or similar to the color of the real object (300). With this aspect, since the color of the background image around an outer periphery of the augmented real image is similar to the color of a portion of the real object, it is possible to clearly present the information to the user through the information image with being harmonized with the real object originally existing in the real landscape.

Further, in the augmented real image display device for a vehicle according to a third aspect dependent on the second aspect, the color information acquisition unit (30, 70) may be configured to acquire, in the real object, the color of an information area (311) including information recognizable by the user and the color of a non-information area (312) not including information recognizable by the user, and the image processing unit (23) may be configured to make an adjustment so that the color of the background image (VB) visually recognized by the user is the same as or similar to the color of the non-information area (312) and is not the same as or similar to the color of the information area (311) in the real object (300). With this aspect, it is possible to display the augmented real image harmonized with the real object without obstructing the information exhibited on the real object.

Further, in the augmented real image display device for a vehicle according to a fourth aspect dependent on either the second or the third aspect, the color information acquisition unit (30, 70) may be configured to detect a background area (313) with relatively little variation in color in the non-information area (312), and the display position adjustment unit (22) may be configured to control the position of the augmented real image (V) so that at least a portion of the augmented real image (V) projects from the real object (300) and adjoins or at least partly overlaps the background area (313). With this aspect, it is possible to arrange the augmented real image in the vicinity of an area with little variation in color in the real object, and make it easy to match the color of the augmented real image with the color of the real object.

Further, in the augmented real image display device for a vehicle according to a fifth aspect dependent on any one of the first to fourth aspects, the image processing unit (23) may be configured to perform at least one of blur processing, translucent processing, and gradation processing to blur at least an outer edge of the augmented real image (V). With this aspect, it is possible to make it more easily to harmonize the augmented real image with the real object and thus to concentrate on the driving operation with being less likely to turn visual attention to the image.

Further, the augmented real image display device for a vehicle according to a sixth aspect dependent on any one of the first to fifth aspects may further include a gaze information acquisition unit (40) configured to detect a gazing position of the user, and the image processing unit (23) may be configured to, when the gazing position detected by the gaze information acquisition unit (40) moves onto the real object (300), make an adjustment so that the color of the augmented real image (V) visually recognized by the user is not the same as or similar to the color of the real object (300). With this aspect, it is possible to change the color of the augmented real image in accordance with the gazing position of the user, and accordingly, when the gazing position of the user is not on the real object, displaying the color of the augmented real image displayed in the vicinity of the real object in a similar color to the real object makes it hard for the user to turn visual attention to the augmented real image. In addition, when the gazing position of the user moves onto the real object, changing the color of the augmented real image displayed in the vicinity of the real object into a different color from the real object makes it easy for user to distinguish between the real object and the augmented real image, and thus makes it easy to recognize the information indicated by the augmented real image.

Further, the augmented real image display device for a vehicle according to a seventh aspect dependent on any one of the first to fifth aspects may further include a gaze information acquisition unit (40) configured to detect a gazing position of the user, the display position adjustment unit (22) may be configured to arrange an internal augmented real image (V4) in an internal area (400) of the vehicle, and the image processing unit (23) may be configured to, either when the gazing position detected by the gaze information acquisition unit (40) is in the internal area (400) or until a predetermined time elapses from when the gazing position is moved out of the internal area (400), make an adjustment so that the color of the augmented real image (V) visually recognized by the user is not the same as or similar to the color of the real object (300), and configured to, either when the gazing position detected by the gaze information acquisition unit (40) moves from the internal area (400) to another area or when a predetermined time elapses from when the gazing position is moved out of the internal area (400), gradually change the color of the augmented real image (V) so that the color of the augmented real image (V) becomes the same as or similar to the real object (300). With this aspect, since the color of the augmented real image is not displayed in a similar color to the real object when the user moves his/her line of sight from the internal area of the vehicle to the other area, it is possible to make it easy for the user to recognize where the augmented real image is displayed. After that, gradually changing the color of the augmented real image so as to become the color of the real object makes it possible for the user to temporarily grasp the position of the augmented real image and also to concentrate on the driving operation with being less likely to turn visual attention to the image.

Further, in the augmented real image display device for a vehicle according to an eighth aspect dependent on any one of the first to seventh aspects, the object selection unit (21) may be configured to select the real object (300) satisfying a first selection condition including the real object (300) having relevance to the presentation information indicated by the augmented real image (V), and to select, when determining that there is no real object (300) satisfying the first selection condition in the foreground (200), the real object (300) satisfying a second selection condition different from the first selection condition, and the image processing unit (23) may be configured to make an adjustment so that the color of the augmented real image (V) visually recognized by the user is not the same as or similar to the color of the real object (300) satisfying the second selection condition. With this aspect, even when there is no real object satisfying the first selection condition having higher priority in the foreground, it is possible to display the augmented real image in the vicinity of another real object, and thus to display the augmented real image without obstructing the field of view of the user. In addition, when the augmented real image is displayed in the vicinity of the real object satisfying the second selection condition that is not the first selection condition having higher priority, displaying the augmented real image in a color different from the color of the real object makes it possible to easily distinguish between the augmented real image and the real object in displaying.

### BRIEF DESCRIPTION OF THE DRAWINGS

FIG. 1 is an illustration for a display example of an augmented real image by an augmented real image display device for a vehicle according to an embodiment of the present invention.

FIG. 2 is an illustration for a display example of an augmented real image by a modification of the augmented real image display device for a vehicle of the embodiment.

FIG. 3 is a block diagram functionally illustrating a configuration of the augmented real image display device for a vehicle of the embodiment.

FIG. 4 is an illustration for a display example of an augmented real image by the augmented real image display device for a vehicle according to the embodiment.

FIG. 5 is an illustration for a display example of an augmented real image by the augmented real image display device for a vehicle according to the embodiment.

FIG. 6 is a flowchart illustrating an operation of the augmented real image display device for a vehicle of the embodiment.

### MODE FOR CARRYING OUT THE INVENTION

Below, embodiments according to the present invention will be described with reference to the accompanying drawings. Note that, the present invention is not limited to the following embodiments (including the contents of the drawings). It is of course that modification (including deletion of constituent elements) can be applied to the following embodiments. Furthermore, in the following description, in order to facilitate the understanding of the present invention, a description of known technical matters will be omitted as appropriate.

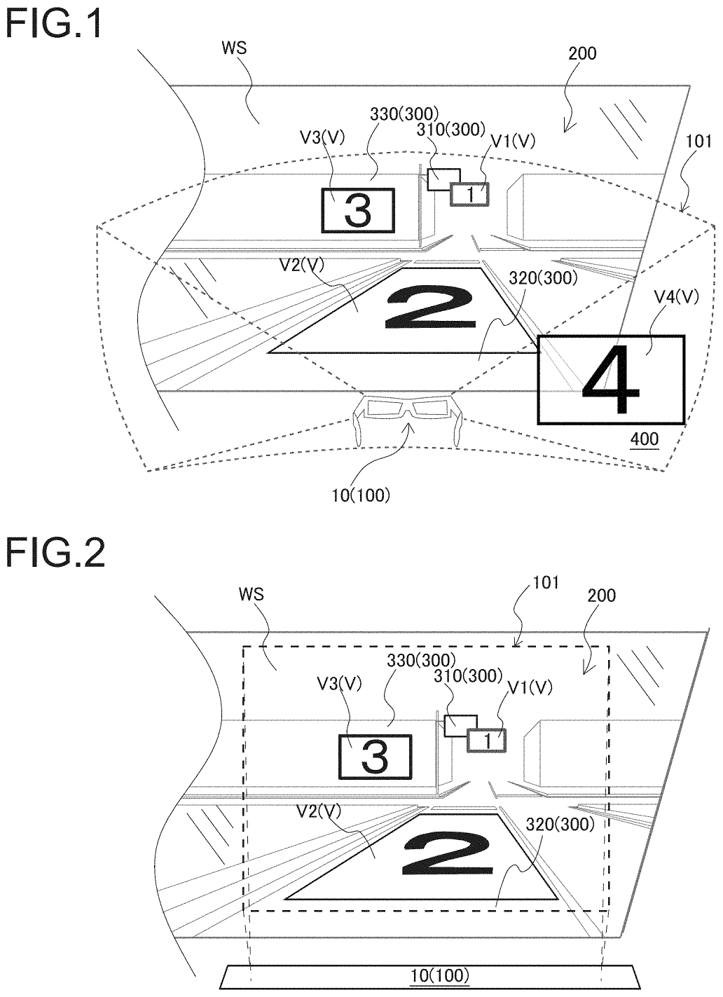

FIG. 1 is an illustration for a display example of an augmented real image display device for a vehicle (hereinafter also referred to as a display device) 100 according to an embodiment of the present invention. The display device 100 according to the present embodiment provides visual recognition of an augmented real image V in the vicinity of a real object 300 existing in a foreground 200 that is a real space visually recognized through a windshield WS of a vehicle, thus to form Augmented Reality (AR). A user (typically a vehicle driver) who rides in the vehicle wears an image display unit 10 including a head-mounted display (hereinafter referred to as an HMD) device on the head and sits on the seat of the vehicle, to visually recognize the augmented real image V that is displayed by the image display unit 10 as being superimposed on the foreground 200 through the windshield WS of the vehicle. The display device 100 according to the present embodiment displays, for example, a first augmented real image V1 in the vicinity of a first real object 310 that is a road sign existing in the foreground 200, displays a second augmented real image V2 as overlapping with a second real object 320 that is a road surface, and displays a third augmented real image V3 as overlapping with a third real object 330 that is a building. Further, since the image display unit 10 of the display device 100 illustrated in FIG. 1 is an HMD device, an augmented real image V4 can be displayed on an internal area 400 of the vehicle, such as an A pillar, for example. It is noted that the image display unit 10 including the HMD device has a predetermined display area 101 and displays the augmented real images V for the real objects 300 included in the display area 101.

(Another Example of the Image Display Unit 10)

FIG. 2 is an illustration for a display example of the augmented real image V according to another example of the image display unit 10 in the display device 100. The above-described image display unit 10 of the display device 100 in FIG. 1 is an HMD device, but the image display unit 10 of the display device 100 illustrated in FIG. 2 differs in that it is a Head-Up Display (HUD) device and the other respects are the same. In the display device 100, a predetermined area of the windshield (which is an example of a projection target member) WS is the display area 101 in which the augmented real image V is displayable, and the augmented real image V is displayed for the real object 300 that exists in the foreground 200 through the display area 101.

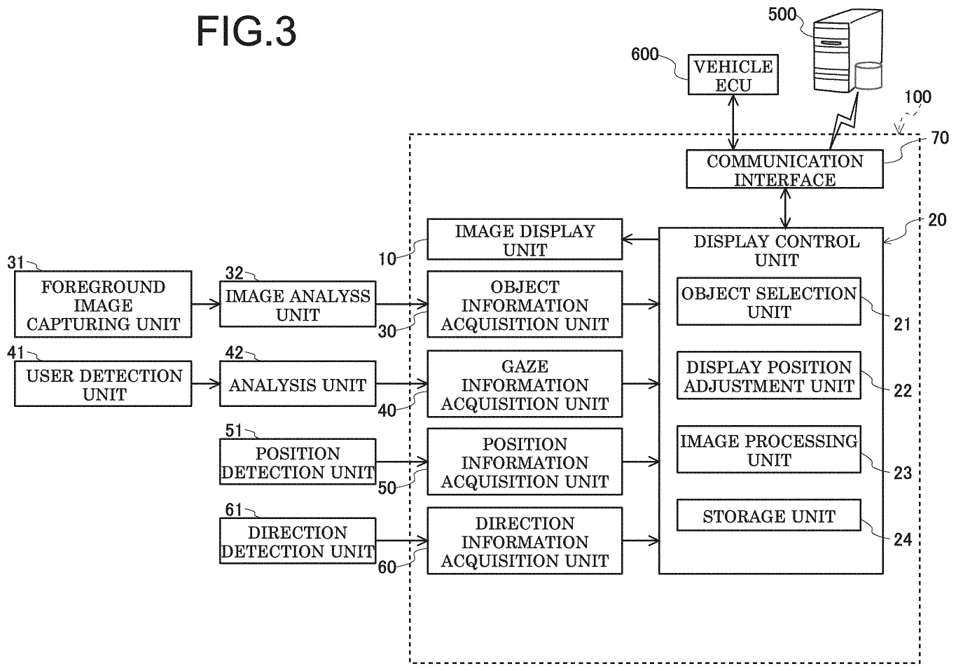

Next, the description proceeds with reference to FIG. 3. FIG. 3 is an illustration for a system configuration of the augmented real image display device 100 for a vehicle.

The display device 100 includes the image display unit 10, a display control unit 20, an object information acquisition unit (color information acquisition unit) 30, a gaze information acquisition unit 40, a position information acquisition unit 50, a direction information acquisition unit 60, and a communication interface 70. The display device 100 is communicatively connected to a cloud server (external server) 500 and a vehicle ECU 600 via the communication interface 70. The communication interface 70 may include a wired communication function such as a USB port, a serial port, a parallel port, an OBD II, and/or any other suitable wired communication port. A data cable from the vehicle is connected to the display control unit 20 of the display device 100 via the communication interface 70. It is noted that in other embodiments, the communication interface 70 may include a wireless communication interface using Bluetooth (registered trademark) communication protocol, IEEE 802.11 protocol, IEEE 802.16 protocol, a shared wireless access protocol, a wireless USB protocol, and/or any other suitable wireless technology. The display device 100 acquires image data of the augmented real image V from the cloud server 500 or the vehicle ECU 600 via the communication interface 70, and displays the augmented real image V based on the image data in the vicinity of the real object 300 determined by the display control unit 20. It is noted that the image data may be partly or all stored in a storage unit 24 of the display control unit 20 described below, and the display control unit 20 may be configured to read the image data stored in the storage unit 24 according to information obtained from the cloud server 500, the vehicle ECU 600, and the like to display the augmented real image V.

The display control unit 20 receives real object information including position information and color information of the real object 300 acquired by the object information acquisition unit 30 described below; gaze information indicating a gazing position of the user acquired by the gaze information acquisition unit 40; position information indicating the current position of the vehicle or the display device 100 acquired by the position information acquisition unit 50; direction information indicating a direction in which the vehicle or the display device 100 is directed, acquired by the direction information acquisition unit 60; and image data acquired by the communication interface 70 from the cloud server 500 and/or the vehicle ECU 600. The display control unit 20 controls the position and color of the augmented real image V displayed by the image display unit 10 so that the augmented real image V is arranged in the vicinity of a specific real object 300 existing in the foreground 200 of the vehicle and has a portion with the same color as the real object 300.

The display control unit 20 includes an object selection unit 21 that selects a specific real object 300 for which the augmented real image V is to be arranged in the vicinity, a display position adjustment unit 22 that adjusts a relative position at which the augmented real image V with respect to the specific real object 300 selected by the object selection unit 21 is displayed, an image processing unit 23 that can adjust the color and brightness of the augmented real image V, and the storage unit 24 that stores the image data.

The object selection unit 21 selects the specific real object 300 for which the augmented real image V is to be displayed in the vicinity from among the real objects 300 extracted by the object information acquisition unit 30 from the foreground 200. The specific real object 300 to be selected satisfies a first selection condition assigned to each augmented real image V (image data). The first selection condition preferably includes relevance to presentation information indicated by the augmented real image V. For example, the first selection condition assigned to the augmented real image V indicating a route on the way to the destination is the real object 300 being a guide sign. However, the first selection condition may not include relevance to the presentation information indicated by the augmented real image V. Further, the first selection condition may be not fixed and be changed. Specifically, it may be automatically changed depending on a change in the environment in which the vehicle travels, the state of the user, or the like, or may be changed by an operation of the user.

Further, when the object selection unit 21 determines that there is no real object 300 satisfying the first selection condition in the foreground 200, the object selection unit 21 selects a real object 300 satisfying a second selection condition that is different from the first selection condition. In other words, the object selection unit 21 preferentially selects the real object 300 satisfying the first selection condition over the real object 300 satisfying the second selection condition. It is noted that the object selection unit 21 may not select a specific real object 300 when there is no real object 300 satisfying such a condition. In this case, the augmented real image V is displayed so that it is fixed in a predetermined area in the display area 101.

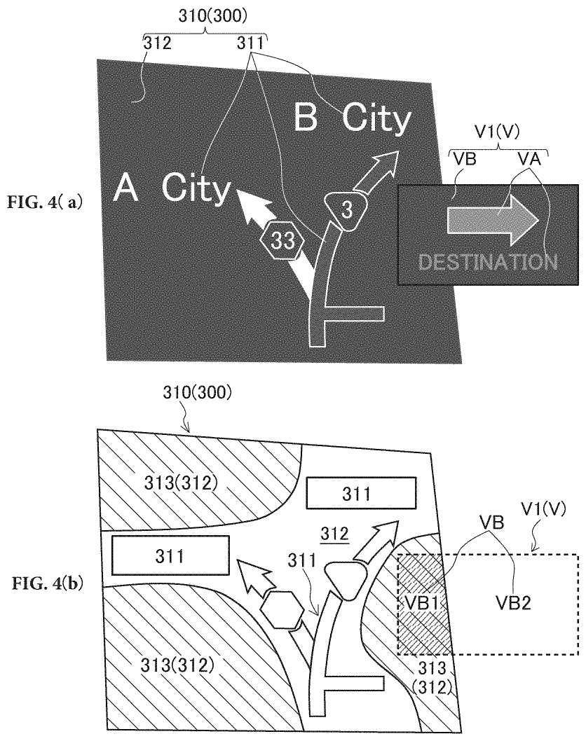

The display position adjustment unit 22 determines a relative position at which the augmented real image V is to be displayed with respect to the specific real object 300 selected by the object selection unit 21, based on the position information of the real object 300 acquired by the object information acquisition unit 30. Further, the display position adjustment unit 22 may determine a display position of the augmented real image V so that the augmented real image V adjoins or partly overlaps a non-information area 312 (see FIG. 4) different from an information area 311 (see FIG. 4) including information recognizable by the user in the real object 300.

The image processing unit 23 adjusts the color of the augmented real image V to be displayed by the image display unit 10. The image processing unit 23 adjusts the color of the augmented real image V based on the color information indicating the color of the real object 300 acquired by the object information acquisition unit (color information acquisition unit) 30 described below, and makes an adjustment so that the color of a portion of the augmented real image V is the same as or similar to the color of the real object 300. Further, the image processing unit 23 may adjust the color of the augmented real image V based on the gaze information indicating the gazing position of the user acquired by the gaze information acquisition unit 40 (its details will be described below).

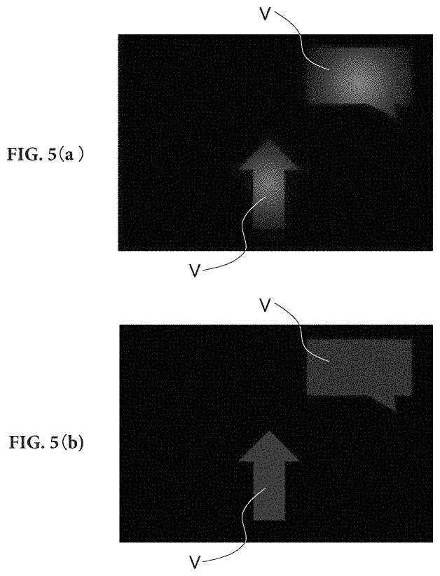

Further, the image processing unit 23 may perform a shading processing on part or all of the augmented real image V to be displayed by the image display unit 10. The shading processing includes blur processing, translucent processing, and gradation processing to blur at least an outer edge of the augmented real image V. FIG. 5 is an example of the shading processing. FIG. 5(a) is an is an illustration for an example in which the translucent processing has been performed on the outer edge of the augmented real image V, and FIG. 5(b) is an illustration for an example in which the translucent processing has been performed on the entire augmented real image V. As a result, it is possible to harmonize the augmented real image V with the real object 300 in displaying.

The object information acquisition unit 30 is an input interface for acquiring the position information of the real object 300 on the foreground 200. The position information is a result of analyzing, by an image analysis unit 32, a captured image of the foreground 200 captured by at least one image capturing camera (foreground image capturing unit) 31 provided on the vehicle or the image display unit 10. The acquired position information of the real object 300 is output to the display device 100.

(Color Information Acquisition Unit)

The object information acquisition unit 30 may further function as a color information acquisition unit that can acquire the color information of the real object 300. Specifically, the foreground image capturing unit 31 is preferably a color camcorder or an infrared camera that can detect the color of the real object 300, and the object information acquisition unit 30 may acquire the color information of the real object 300 on the foreground 200, which is a result of analyzing, by the image analysis unit 32, a color image of the foreground 200 captured by the foreground image capturing unit 31. It is noted that the color information acquisition unit may be configured to acquire, in the real object 300, the color of the information area 311 (see FIG. 4(a)) including information recognizable by the user and the color of the non-information area 312 (see FIG. 4(a)) not including information recognizable by the user. The information recognizable by the user is, for example, a character string, a symbol, and the like, and can be identified by the image analysis unit 32 applying one or more algorithms to the captured image captured by the foreground image capturing unit 31. Further, the color information acquisition unit may be configured to acquire the position information of a background area 313 (see FIG. 4(b)) with relatively little variation in color in the non-information area 312.

Further, the object information acquisition unit 30 may acquire type information for identifying the type of the real object 300 on the foreground 200, which is a result of analyzing, by the image analysis unit 32, the captured image of the foreground 200 captured by the foreground image capturing unit 31. The types of real object 300 include, for example, a road sign, a road surface, a building, and the like, but are not limited to these as long as they exist in the foreground 200 and are identifiable. The image analysis by the image analysis unit 32 is performed by matching with a shape stored in advance in a storage unit of the image analysis unit 32. However, the image analysis may include an additional estimation based on the position of the real object 300 in the captured image or an additional estimation based on the position information of the vehicle or the display device 100, as described below. It is noted that the color of the real object 300 may be estimated according to the type of the real object 300. Accordingly, as a modification, the display control unit 20 may estimate the color of the real object 300 based on the type information acquired from the object information acquisition unit 30. Specifically, the object information acquisition unit 30 can acquire real object information (position information, color information, and type information of the real object 300) and output the information to the display control unit 20.

(Another Example of Color Information Acquisition Unit)

As another example, the communication interface 70 described below may have a function as the color information acquisition unit. For example, the cloud server 500 stores, for example, position information, shape information, color information, and the like of the object information acquisition unit 300 such as a road and a building together with map information, and accordingly, the communication interface 70 can acquire the color information together with the position information of the real object 300 from the cloud server 500.

The gaze information acquisition unit 40 is an input interface that acquires gazing position information indicating a gazing position of the user, which is a result of analyzing, by an analysis unit 42, a captured image of the user's eyes captured by a user detection unit 41 including an image capturing camera that captures the user. In the case of detection of line of sight, the image of the user's eyes is captured by a CCD camera or the like, and the direction of the user's line of sight is detected as a gazing position by using pattern matching processing of image processing technology.

The position information acquisition unit 50 acquires the position information of the vehicle or the display device 100 detected by a position detection unit 51 including a GNSS (Global Navigation Satellite System) or the like, and outputs the position information to the display control unit 20.

The direction information acquisition unit 60 acquires the direction information indicating the direction of the vehicle or the display device 100 detected by a direction detection unit 61 including a direction sensor, and outputs the direction information to the display control unit 20.

The display control unit 20 outputs the position information of the vehicle or the display device 100 acquired by the position information acquisition unit 50 and the direction information of the vehicle or the display device 100 acquired by the direction information acquisition unit 60 to the cloud server 500 and/or the vehicle ECU 600 via the communication interface 70. Subsequently, based on the received position information and direction information of the vehicle or the display device 100, the cloud server 500 and the vehicle ECU 600 outputs, to display control unit 20 via the communication interface 70, the image data of the augmented real image V to be displayed by the display device 100. It is noted that as another example, the cloud server 500 and the vehicle ECU 600 may output specification data for specifying an augmented real image V to be displayed by the display device 100 to the display control unit 20 via the communication interface 70 based on the received position information and direction information of the vehicle or the display device 100, and the display control unit 20 may read the image data stored in the storage unit 24 based on the received specification data. Further, as another example, the cloud server 500 and the vehicle ECU 600 may output, to the display control unit 20, the image data of the augmented real image V or specification data for specifying the augmented real image V to be displayed, based on other information different from the position information and direction information of the vehicle or the display device 100.

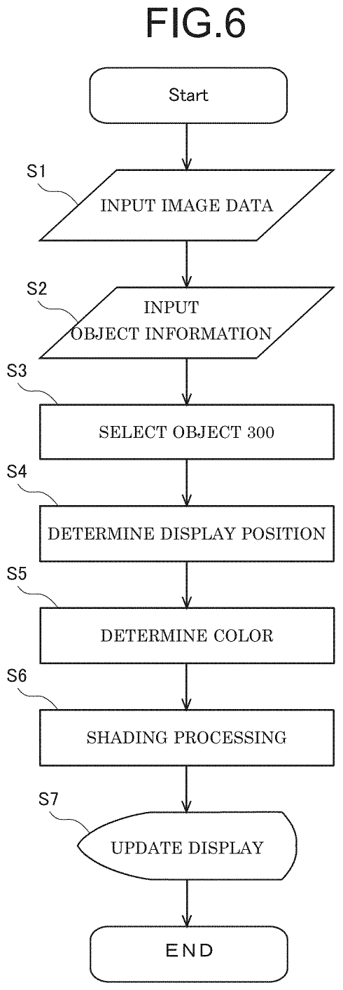

FIG. 6 is a flowchart generally illustrating an operation procedure of the augmented real image display device 100 for a vehicle. In step 51, the display control unit 20 receives image data from the cloud server 500 and/or the vehicle ECU 600 via the communication interface 70.

Next, in step S2, the display control unit 20 receives, via the object information acquisition unit 30, the real object information including the type information, the position information, and the color information of the real object 300 existing in the foreground 200, which are results of analysis by the image analysis unit 32 of the captured image of the foreground 200 of the vehicle captured by the foreground image capturing unit 31. Further, the display control unit 20 receives, via the object information acquisition unit 30, the position information of the information area 311 (see FIG. 4(a)) including information recognizable by the user and the position information of the non-information area 312 (see FIG. 4(a)) not including information recognizable by the user or the position information of the background area 313 (see FIG. 4(b)) with relatively little variation in color in the non-information area 312, in the real object 300, which are results of analyzing the captured image by the image analysis unit 32.

Next, in step S3, the object selection unit 21 of the display control unit 20 refers to the type information and the position information of the real object 300 received in step S2, and selects a specific real object 300 satisfying the first selection condition assigned to the image data received in step S1. Further, when the object selection unit 21 determines that there is no real object 300 satisfying the first selection condition in the foreground 200, the object selection unit 21 selects a real object 300 satisfying a second selection condition that is different from the first selection condition.

Next, in step S4, the display position adjustment unit 22 of the display control unit 20 determines a display position of the augmented real image V so that the augmented real image V does not overlap the information area 311 including information recognizable by the user in the real object 300. Specifically, the display position adjustment unit 22 determines a display position of the augmented real image V so that the augmented real image V adjoins or at least partly overlap the non-information area 312, preferably the background area 313, of the real object 300, based on the position information of the information area 311 (see FIG. 4(a)) received in step S1, the position information of the non-information area 312, or the position information of the background area 313.

Next, in step S5, the image processing unit 23 of the display control unit 20 determines the color of the augmented real image V so that the color of a portion of the augmented real image V is the same as or similar to the colors of the real object 300, based on the color information of the real object 300 received in step S1. Specifically, an adjustment is made so that the color of a background image VB (see FIG. 4(a)) surrounding at least a portion of the periphery of an information image VA (see FIG. 4(a)) indicating the presentation information in the augmented real image V is the same as or similar to the color of the real object 300.

Next, in step S6, the image processing unit 23 of the display control unit 20 performs the shading processing such as blur processing, translucent processing, and gradation processing on the augmented real image V.

Next, in step S7, the display control unit 20 causes the image display unit 10 to display the augmented real image V subjected to the shading processing in step S6 at the position determined in step S4 in the color determined in step S5.

First to fourth embodiments will be specifically described below mainly with reference to FIG. 4.

### First Embodiment

In the first embodiment, the image processing unit 23 makes an adjustment so that the color of the background image VB visually recognized by the user is the same as or similar to the color of the real object 300. When the non-information area 312 of the first real object 310 is blue, the color of the background image VB of the first augmented real image V1 is set to blue or a similar color to blue. It is noted that the similar color in the present invention is a color in which differences in R, G, and B values in the RGB space each fall within a range of ±15% or less, and/or differences in H (hue), S (saturation), and V (value) values in the HSV space each fall within a range of ±15% or less. The image processing unit 23 does not need to make the entire background image VB the same as the color of the real object 300, but may partly make the background image VB the same as that, and when the color of 50% or more of the entire background image VB is similar to the real object 300, it is possible to harmonize the augmented real image V with the real object 300. It is noted that the image processing unit 23, if an area close to the real object 300 in the background image VB has a similar color to the real object 300, can harmonize the augmented real image V with the real object 300 even if about 25% or more of the entire background image VB has the similar color. It is noted that the image processing unit 23 may make an adjustment so that the color of the background image VB visually recognized by the user is not similar to the color of the information area 311 of the real object 300.

It is noted that the augmented real image V does not necessarily have the background image VB. In other words, the augmented real image V may be composed of only the information image VA indicating the presentation information. In this case, the image processing unit 23 makes an adjustment so that the color of part or all of the outermost edge of the information image VA is the same as or similar to the color of the real object 300.

### Second Embodiment

The display position adjustment unit 22 controls the position of the augmented real image V so that at least a portion of the augmented real image V projects from the real object 300 and adjoins or at least partly overlaps the non-information area 312 of the real object 300. In other words, the display position adjustment unit 22 may arrange the augmented real image V so that the augmented real image V has an area VB2 (see FIG. 4(b)) that does not overlap the real object 300.

### Third Embodiment

In the third embodiment, when the gazing position of the user detected by the gaze information acquisition unit 40 moves from another position onto the real object 300 on which the augmented real image V is displayed in the vicinity, the image processing unit 23 makes an adjustment so that the color of the augmented real image V visually recognized by the user is not the same as or similar to the color of the real object 300.

### Fourth Embodiment

In the fourth embodiment, either when the gazing position of the user detected by the gaze information acquisition unit 40 is in the internal area 400 of the vehicle or until a predetermined time elapses from when the gazing position of the user is moved out of the internal area 400, the image processing unit 23 makes an adjustment so that the color of the augmented real image V visually recognized by the user is not the same as or similar to the color of the real object 300, and either when the gazing position moves from the internal area 400 to another area or when a predetermined time elapses from when the gazing position is moved out of the internal area 400, the image processing unit 23 gradually changes the color of the augmented real image V so that the color of the augmented real image V becomes the same as or similar color to the real object 300.

### INDUSTRIAL APPLICABILITY

The present invention is suitable for a transmissive head-mounted display device or a head-up display device, which allow a viewer to visually recognize a virtual image superimposed on a landscape.

### DESCRIPTION OF REFERENCE NUMERALS

10 Image display unit

20 Display control unit

21 Object selection unit

22 Display position adjustment unit

23 Image processing unit

24 Storage unit

30 Object information acquisition unit (color information acquisition unit)

40 Gaze information acquisition unit

50 Position information acquisition unit

60 Direction information acquisition unit

70 Communication interface (color information acquisition unit)

100 Augmented real image display device for vehicle

101 Display area

200 Foreground

300 Real object

310 First real object

311 Information area

312 Non-information area

313 Background area

320 Second real object

330 Third real object

400 Internal area

500 Cloud server

600 Vehicle ECU

V Augmented real image

VA Information image

VB Background image

WS Windshield

1. An augmented real image display device for a vehicle that displays an augmented real image including presentation information so that the augmented real image is superimposed on a foreground of the vehicle, the augmented real image display device for a vehicle comprising:
an image display unit configured to allow a user to visually recognize the augmented real image;
an object selection unit configured to select a specific real object from the foreground;
a display position adjustment unit configured to control a position of the augmented real image so that the augmented real image adjoins or at least partly overlaps the real object selected by the object selection unit;
a color information acquisition unit configured to acquire color information of the real object; and
an image processing unit configured to make an adjustment so that a color of a portion of the augmented real image visible to the user is a same as or similar to the color of the real object.

2. The augmented real image display device for a vehicle according to claim 1, wherein the augmented real image includes an information image indicating the presentation information, and a background image surrounding at least a portion of a periphery of the information image, and the image processing unit is configured to make an adjustment so that the color of the background image visually recognized by the user is the same as or similar to the color of the real object.

3. The augmented real image display device for a vehicle according to claim 2, wherein
the color information acquisition unit is configured to acquire, in the real object, the color of an information area including information recognizable by the user and the color of a non-information area not including information recognizable by the user, and
the image processing unit is configured to make an adjustment so that the color of the background image visually recognized by the user is the same as or similar to the color of the non-information area and is not the same as or similar to the color of the information area in the real object.

4. The augmented real image display device for a vehicle according to claim 2, wherein
the color information acquisition unit is configured to detect a background area. with relatively little variation in color in the non-information area, and
the display position adjustment unit is configured to control the position of the augmented real image so that at least a portion of the augmented real image projects from the real object and adjoins or at least partly overlaps the background area.

5. The augmented real image display device for a vehicle according to claim 1, wherein the image processing unit is configured to perform at least one of blur processing, translucent processing, and gradation processing to blur at least an outer edge of the augmented real image.

6. The augmented real image display device for a vehicle according to claim 1, further comprising a gaze information acquisition unit configured to detect a gazing position of the user,
wherein the image processing unit is configured to, when the gazing position detected by the gaze information acquisition unit moves onto the real object, make an adjustment so that the color of the augmented real image visually recognized by the user is not the same as or similar to the color of the real object.

7. The augmented real image display device for a vehicle according to claim 1, further comprising a gaze information acquisition unit configured to detect a gazing position of the user,
wherein the display position adjustment unit is configured to arrange an internal augmented real image in an internal area of the vehicle, and
the image processing unit is configured to, either when the gazing position detected by the gaze information acquisition unit is in the internal area or until a predetermined time elapses from when the gazing position is moved out of the internal area, make an adjustment so that the color of the augmented real image visually recognized by the user is not the same as or similar to the color of the real object, and configured to, either when the gazing position detected by the gaze information acquisition unit moves from the internal area to another area or when a predetermined tune elapses from when the gazing position is moved out of the internal area, gradually change the color of the augmented real image so that the color of the augmented real image becomes the same as or similar to the real object.

8. The augmented real image display device for a vehicle according to claim 1, wherein the object selection unit is configured to select the real object satisfying a first selection condition including the real object having relevance to the presentation information indicated by the augmented real image, and to select, when determining that there is no real object satisfying the first selection condition in the foreground, the real object satisfying a second selection condition different from the first selection condition, and the image processing unit is configured to make an adjustment so that the color of the augmented real image visually recognized by the user is not the same as or similar to the color of the real object satisfying the second selection condition.
